(19) United States
(12) Patent Application Publication
(10) Pub. No.: US 2026/0161029 A1
(43) Pub. Date: Jun. 11, 2026

(54) BACKLIGHT MODULE AND METHOD FOR MANUFACTURING SAME, AND DISPLAY DEVICE

(71) Applicants: Beijing BOE Display Technology Co., Ltd., Beijing (CN); BOE Technology Group Co., Ltd., Beijing (CN)

(72) Inventors: Feifei WANG, Beijing (CN); Xinli MA, Beijing (CN); Xibin SHAO, Beijing (CN); Hongming ZHAN, Beijing (CN); Bowen LI, Beijing (CN)

(21) Appl. No.: 18/703,831

(22) PCT Filed: May 23, 2023
(86) PCT No.: PCT/CN2023/095684

§ 371 Date: Apr. 23, 2024

(30) Foreign Application Priority Data
May 23, 2022 (CN) 202210564722.4

(51) Int. Cl. G02F 1/13357; G02F 1/1335; G02F 1/13363

(52) U.S. Cl. CPC G02F 1/13362; G02F 1/133603; G02F 1/133605; G02F 1/133607; G02F 1/133615; G02F 1/133638; G02F 2413/02

(57) ABSTRACT

Provided is a backlight module. The backlight module includes a liquid crystal optical layer, a first quarter wave plate, and a dimming layer which are laminated; wherein the dimming layer includes a plurality of quantum rods, a long axis direction of the quantum rod being consistent with a polarization direction of the first quarter wave plate; the liquid crystal optical layer is configured to transmit a portion of circularly polarized light from a light source to the first quarter wave plate; and the first quarter wave plate is configured to convert the circularly polarized light transmitted by the liquid crystal optical layer into linearly polarized light and emit the linearly polarized light into the dimming layer; wherein the quantum rod is configured to emit light of a color different from a first color under excitation of the linearly polarized light.

### CROSS-REFERENCE TO RELATED APPLICATION

This application is a U.S. national phase application based on PCT/CN2023/095684, filed on May 23, 2023, which claims priority to Chinese patent Application No. 202210564722.4, filed on May 23, 2022 and entitled “BACKLIGHT MODULE AND PREPARATION METHOD THEREOF, AND DISPLAY DEVICE”, the contents of which are incorporated herein by reference in their entireties.

### TECHNICAL FIELD

The present disclosure related the field of backlight technology, and in particular to a backlighting module and a method for manufacturing the same, and a display device.

### BACKGROUND

In the display art, color gamut is used to measure the range of colors that can be displayed by a display device. The larger the gamut, the more colors a display device can display. The wider the color gamut, the more vivid colors a display device can display. Large color gamut and wide color gamut can be collectively referred to as high color gamut. Currently, the demand for high color gamut display devices is growing.

### SUMMARY

Embodiments of the present disclosure provide to a backlighting module and a method for manufacturing the same, and a display device.

According to some embodiments of the present disclosure, a backlight module is provided. The backlight module includes: a liquid crystal optical layer, a first quarter wave plate, and a dimming layer which are laminated, wherein the dimming layer includes a plurality of quantum rods, a long axis direction of the quantum rod is consistent with a polarization direction of the first quarter wave plate;
the liquid crystal optical layer is configured to transmit a portion of circularly polarized light from a light source to the first quarter wave plate;
the first quarter wave plate is configured to convert the circularly polarized light transmitted by the liquid crystal optical layer into linearly polarized light and emit the linearly polarized light into the dimming layer; and
the quantum rod is configured to emit light of a color different from a first color under excitation of the linearly polarized light, such that the dimming layer emits light of a color different from the first color, wherein the first color is a color of the light source.

In some embodiments, the dimming layer includes at least one quantum rod layer, the quantum rod layer includes a plurality of quantum rods disposed in an array, and long axis directions of the plurality of quantum rods in a same quantum rod layer are consistent.

In some embodiments, the at least one quantum rod layer includes a first quantum rod layer and a second quantum rod layer which are laminated in a direction away from the first quarter wave plate;
the first quantum rod layer is configured to emit light of a second color under excitation of the linearly polarized light, and the second quantum rod layer is configured to emit light of a third color under excitation of the linearly polarized light, and the first color, the second color, and the third color are different colors; and
the quantum rod includes a shell and a core disposed within the shell, a long axis direction of the quantum rod in the first quantum rod layer is consistent with a long axis direction of the quantum rod in the second quantum rod layer, and a dimension of the core of the quantum rod in the first quantum rod layer is different from a dimension of the core of the quantum rod in the second quantum rod layer.

In some embodiments, a thickness of the quantum rod layer ranges from 100 μm to 500 μm.

In some embodiments, the backlight module further includes a reflective layer, disposed on a side, away from the first quarter wave plate, of the liquid crystal optical layer;
the liquid crystal optical layer is further configured to reflect another portion of the circularly polarized light from the light source to the reflective layer; and
the reflective layer is configured to reflect light reflected by the liquid crystal optical layer to the liquid crystal optical layer.

In some embodiments, the liquid crystal optical layer is configured to transmit the circularly polarized light from the light source in a first rotation direction to the first quarter wave plate and reflect the circularly polarized light from the light source in a second rotation direction to the reflective layer, and the first rotation direction and the second rotation direction are one of a left rotation direction and a right rotation direction respectively;
the reflective layer is configured to reflect the circularly polarized light in the second rotation direction; and
the liquid crystal optical layer is configured to transmit the circularly polarized light in the first rotation direction in the light reflected by the reflective layer to the first quarter wave plate.

In some embodiments, the backlight module further includes a second quarter wave plate, disposed between the reflective layer and the liquid crystal optical layer.

In some embodiments, an angle between a slow axis direction of the first quarter wave plate and the long axis direction of the quantum rod ranges from 45° to 135°.

In some embodiments, the liquid crystal optical layer includes a cholesteric liquid crystal layer, and the cholesteric liquid crystal layer includes a liquid crystal polymer having a first pitch and a second pitch.

In some embodiments, the backlight module further includes the light source, wherein the light source is a micro light-emitting diode.

In some embodiments, the backlight module further includes a light guide plate, disposed on a side, away from the first quarter wave plate, of the liquid crystal optical layer.

In some embodiments, the backlight module is an edge-lit backlight module or a direct-type backlight module.

According to some embodiments of the present disclosure, a display device is provided. including: a polarizer and the backlight module described in the above embodiments;
wherein the polarizer is disposed on a side, away from the first quarter wave plate in the backlight module, of the dimming layer in the backlight module.

In some embodiments, the liquid crystal optical layer in the backlight module is a left-handed liquid crystal optical layer, and the quantum rod in the dimming layer, the first quarter wave plate, and the polarizer satisfy one of the following relationships:
an angle between a long axis direction of the quantum rod and a slow axis direction of the first quarter wave plate is 45°, and the long axis direction of the quantum rod is parallel to a transmission axis of the polarizer;
an angle between the long axis direction of the quantum rod and the slow axis direction of the first quarter wave plate is 135°, and the long axis direction of the quantum rod is perpendicular to the transmission axis of the polarizer.

In some embodiments, the liquid crystal optical layer in the backlight module is a right-handed liquid crystal optical layer, and the quantum rod in the dimming layer, the first quarter wave plate, and the polarizer satisfy one of the following relationships:
an angle between a long axis direction of the quantum rod and a slow axis direction of the first quarter wave plate is 135°, and the long axis of the quantum rod is parallel to a transmission axis of the polarizer;
the angle between the long axis direction of the quantum rod and the slow axis direction of the first quarter wave plate is 45°, and the long axis direction of the quantum rod is perpendicular to the transmission axis of the polarizer.

According to some embodiments of the present disclosure, a method for manufacturing a backlight module is provided. The method includes:
providing a liquid crystal optical layer, a first quarter wave plate and a dimming layer, wherein the dimming layer includes a plurality of quantum rods;
disposing the first quarter wave plate on a side of the liquid crystal optical layer; and
disposing the dimming layer on a side, away from the liquid crystal optical layer, of the first quarter wave plate, such that a long axis direction of the quantum rods is consistent with a polarization direction of the first quarter wave plate;
wherein the liquid crystal optical layer is configured to transmit a portion of circularly polarized light from a light source to the first quarter wave plate, the first quarter wave plate configured to convert the circularly polarized light transmitted by the liquid crystal optical layer into linearly polarized light and emit the linearly polarized light into the dimming layer, the quantum rod is configured to emit light of a color different a first color under excitation of the linearly polarized light, such that the dimming layer emits light of a color different from the first color, and the first color is a color of the light source.

In some embodiments, providing the dimming layer includes:
providing the quantum rods;
acquiring at least one quantum rod layer by disposing a plurality of quantum rods in an array on a side of a first substrate;
aligning the quantum rod layer such that long axis directions of the plurality of quantum rods in the quantum rod layer are consistent; and
acquiring the dimming layer by disposing a second substrate on a side, away from the first substrate, of the at least one quantum rod layer.

In some embodiments, providing the quantum rods includes:
synthesizing a seed crystal, wherein the seed crystal includes a quantum rod material;
acquiring a core by activating a surface of the seed crystal; and
acquiring the quantum rod by wrapping a shell around the core.

In some embodiments, providing the liquid crystal optical layer includes:
preparing a liquid crystal composite system having a first pitch in a first temperature environment based on self-assembling donors and acceptors containing hydrogen bonds, and a liquid crystal system;
injecting the liquid crystal composite system into a liquid crystal cell in second temperature environment, such that the hydrogen bonds in the liquid crystal composite system are broken and the liquid crystal composite system is converted to a liquid crystal composite system having a second pitch;
acquiring the liquid crystal optical layer by placing the liquid crystal cell containing the liquid crystal composite system in the first temperature environment to cause a portion of the hydrogen bonds in the liquid crystal composite system to self-assemble, wherein the liquid crystal optical layer includes a liquid crystal polymer having the first pitch and the second pitch not uniformly distributed.

In some embodiments, providing the liquid crystal optical layer includes:
preparing a dye layer on a first substrate;
preparing a liquid crystal layer on a second substrate;
forming a liquid crystal cell by interfacing a side, having the dye layer, of the first substrate with a side, having the liquid crystal layer, of the second substrate;
heat treating a side, away from the dye layer, of the first substrate, such that dye molecules of the dye layer thermally diffuse toward the liquid crystal layer;
acquiring the liquid crystal optical layer by UV irradiating the side, away from the dye layer, of the first substrate, wherein the liquid crystal optical layer includes a plurality of liquid crystal polymers having a pitch gradient, and the pitch gradient includes a first pitch and a second pitch.

### BRIEF DESCRIPTION OF DRAWINGS

FIG. 1 is a schematic structural diagram of a backlight module according to some embodiments of the present disclosure;

FIG. 2 is a schematic structural diagram of a quantum rod according to some embodiments of the present disclosure;

FIG. 3 is a schematic structural diagram of a dimming layer according to some embodiments of the present disclosure;

FIG. 4 is a schematic structural diagram of another backlight module according to some embodiments of the present disclosure;

FIG. 5 is a schematic diagram of light transmission path in a backlight module according to some embodiments of the present disclosure;

FIG. 6 is a schematic structural diagram of still another backlight module according to some embodiments of the present disclosure;

FIG. 7 is a schematic diagram of light transmission path in still another backlight module according to some embodiments of the present disclosure;

FIG. 8 is a schematic structural diagram of a display device according to some embodiments of the present disclosure;

FIG. 9 is a flowchart of a method for manufacturing a backlight module according to some embodiments of the present disclosure;

FIG. 10 is a flowchart of an implementation process for preparing a dimming layer according to some embodiments of the present disclosure;

FIG. 11 is an illustrated schematic diagram of preparing a quantum rod according to some embodiments of the present disclosure;

FIG. 12 is a schematic diagram of a structure upon forming a quantum rod layer on a first substrate according to some embodiments of the present disclosure;

FIG. 13 is a flowchart of an implementation process for preparing a liquid crystal optical layer according to some embodiments of the present disclosure; and

FIG. 14 is a flowchart of another implementation process for preparing a liquid crystal optical layer according to some embodiments of the present disclosure.

### DETAILED DESCRIPTION

Embodiments of the present disclosure are described below in conjunction with the accompanying drawings in the present disclosure. It should be understood that the embodiments described below, in conjunction with the accompanying drawings, are exemplary descriptions for explaining the technical solutions of the embodiments of the present disclosure, and do not constitute a limitation on the technical solutions of the embodiments of the present disclosure.

It is to be appreciated by those skilled in the art that the singular forms “an,” “a,” “said,” and “the” used herein may also include the plural form, unless otherwise stated. It should be understood that the term “including” used in the description of the present disclosure refers to the presence of the described features, integers, steps, operations, elements and/or components, but does not preclude the implementation of other features, information, data, steps, operations, elements, components and/or combinations thereof, and the like, as supported in the art. It should be understood that when we refer to an element being “connected” or “coupled” to another element, one element may be directly connected or coupled to the other element, or it may refer to the connection between one element and the other element being realized through an intermediate element. The term “and/or” used herein refers to at least one of the items defined by the term, e.g., “A and/or B” may be realized as “A,” “B,” or “A and B.”

In order to make the objects, technical solutions, and effects of the present disclosure clearer, the embodiments of the present disclosure are to be described in detail below in conjunction with the accompanying drawings.

Typically, a high color gamut liquid crystal display (LCD) is realized by using a liquid crystal display panel with a high color gamut backlight module. The high color gamut backlight module is mainly realized by using quantum dot technology, high color gamut backlight or micro light emitting diode backlight technology. At present, the micro light-emitting diode backlighting technology applied to LCD is usually realized by using blue micro light-emitting diodes with quantum dots film, or using blue micro light-emitting diodes with phosphor film.

However, because the blue micro light-emitting diode is the ordinary color gamut of the backlight, and quantum dot film and phosphor film transmittance are lower, resulting in a lower light utilization rate of the backlight module, which leads to the color gamut of the LCD is also lower. In the case that the brightness and color gamut of LCD is improved in the related art, it is needed to increase power consumption.

The technical solutions of the present disclosure and how the technical solutions of the present disclosure solve the above technical problems are described in detail below by specific embodiments. It should be noted that the following embodiments are referred to, borrowed or combined with each other, and the same terms, similar features and similar implementation steps in different embodiments is not described repeatedly.

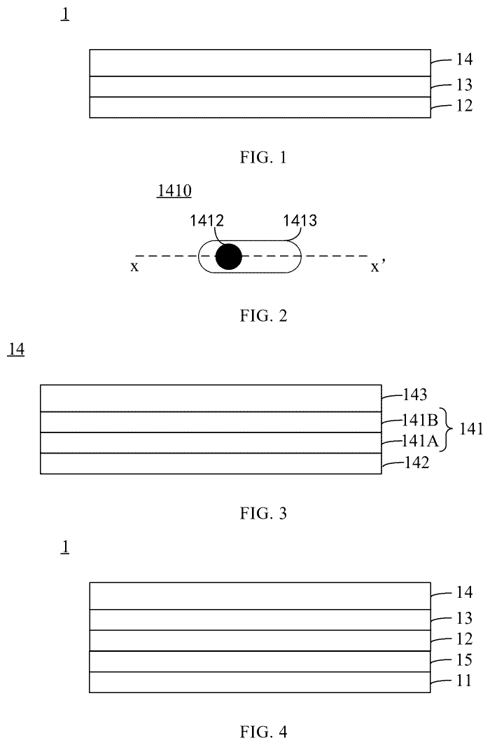

FIG. 1 is a schematic structural diagram of a backlight module according to some embodiments of the present disclosure. As shown in FIG. 1, the backlight module 1 includes: a liquid crystal optical layer 12, a first quarter wave plate 13, and a dimming layer 14 which are laminated. The dimming layer 14 includes a plurality of quantum rods. A long axis direction of the quantum rods is consistent with a polarization direction of the first quarter wave plate 13.

The long axis direction of the quantum rods is the same as the polarization direction of the first quarter wave plate 13, which is not necessarily zero error. Specifically, the long axis direction of the quantum rod being the same as the polarization direction of the first quarter wave plate 13 is that the angle between the long axis direction of the quantum rod and the polarization direction of the first quarter wave plate 13 is less than a certain error threshold. The error threshold is, for example, 10 degrees. That is, in the case that the angle between the long axis direction of the quantum rod and the polarization direction of the first quarter wave plate 13 is less than or equal to 10 degrees, the long axis direction of the quantum rod is considered to be the same as the polarization direction of the first quarter wave plate 13.

In some embodiments, the preparation material of the first quarter wave plate 13 includes a liquid crystal material. The polarization direction of the first quarter wave plate 13 is the long axis direction of the liquid crystal molecules within the first quarter wave plate 13.

In some embodiments, the preparation material of the first quarter wave plate 13 includes a thin film material. The polarization direction of the first quarter wave plate 13 is the stretching direction of the thin film material.

In some embodiments, the long axis direction of the quantum rod refers to the direction of the long axis of the quantum rod. In some embodiments, FIG. 2 is a schematic structural diagram of a quantum rod according to some embodiments of the present disclosure. As shown in FIG. 2, the quantum rod 1410 includes a shell 1413 and a core 1412 disposed within the shell 1413. The long axis direction of the quantum rod 1410 is direction xx′. Due to the structure of the quantum rod, the total reflection of the quantum rod in the long axis direction is comparable to that of a quantum dot, but the quantum rod has no total reflection in the short axis direction. Thus, the light extraction rate of the quantum rods is higher than that of the quantum dots, and accordingly, the light extraction rate of the dimming layer 14 including a plurality of quantum rods in the long axis direction is higher than that of the quantum dot film layer. The quantum rods have a polarization property in that the quantum rods absorb and emit polarized light along the long axis direction.

In the backlight module 1 shown in FIG. 1, the liquid crystal optical layer 12 is configured to transmit a portion of the circularly polarized light from the light source to the first quarter wave plate 13. The first quarter wave plate 13 is configured to convert the circularly polarized light transmitted by the liquid crystal optical layer 12 into a linearly polarized light and to emit the linearly polarized light into the dimming layer 14. The quantum rods are configured to emit a color other than the first color of the light when excited by the linearly polarized light, such that the dimming layer 14 emits the light of a color other than the first color. The first color is a color of the light source.

The side, away from the first quarter wave plate 13, of the dimming layer 14 is the light-out side of the dimming layer 14. The light-out side of the dimming layer 14 is regarded as the light-out side of the backlight module 1.

In the backlight module in the embodiments of the present disclosure, the first quarter wave plate is capable of converting the circularly polarized light emitted from the liquid crystal optical layer into linearly polarized light. Because the absorption of the polarized light by the quantum rod is anisotropic, in the case that the incident polarized light is aligned with the long axis direction of the quantum rod, the quantum rod absorbs the incident polarized light most strongly, and accordingly, the fluorescence intensity of the quantum rod is strongest. Therefore, by aligning the polarization direction of the first quarter wave plate with the long axis direction of the quantum rod in the dimming layer, that is, by aligning the polarization direction of the linearly polarized light emitted from the first quarter wave plate with the long axis direction of the quantum rod, it is possible to maximize the absorption of the polarized light in the long axis direction of the quantum rod and maximize the excitement of the quantum rod to emit the fluorescence, thereby increasing the excitation efficiency of the quantum rod in the dimming layer, improving the utilization rate of the backlight, and achieving a high color gamut of the backlight module. By a structure including a liquid crystal optical layer, a first quarter wave plate, and a dimming layer including the quantum rods in the backlight module, the embodiments of the present disclosure realize a high color gamut backlight module without increasing power consumption, and are able to greatly improve the light efficiency of the display device. In addition, the backlight module has a simple structure and is realized at a lower cost, which is more conducive to widespread use.

In some embodiment, the dimming layer 14 includes at least one quantum rod layer. That is, the dimming layer 14 includes one layer of quantum rods. Alternatively, the dimming layer 14 includes a plurality of quantum rod layers. Each of the quantum rod layer includes a plurality of quantum rods arranged in an array, and the plurality of quantum rods disposed in a same quantum rod layer have the same long axis direction.

In the embodiments of the present disclosure, the dimming layer 14 includes the quantum rod layer, which is capable of improving the transmittance rate of the polarized light, compared to the conventional quantum dot film layer. The transmittance of the dimming layer 14 is related to the arrangement direction of the quantum rods in the quantum rod layer. In the case that the long axis direction of the quantum rods is the same as the polarization direction of the incident polarized light, the quantum rods have the highest rate of light absorption and light extraction, and accordingly, the transmittance of the dimming layer 14 is also the highest. In the embodiments of the present disclosure, the light extraction rate of the dimming layer 14 is improved by arranging the long axis direction of the plurality of quantum rods of the quantum rod layer to be the same as the long axis direction (the alignment direction), thereby improving the light transmission rate of the dimming layer 14.

It should be noted that in the case that the dimming layer 14 includes a plurality of quantum rod layers, the core of the plurality of quantum rods within one quantum rod layer have the same size, and the dimensions of the cores of the quantum rods in the different quantum rod layers are different. The dimension of the core of the quantum rods determines the wavelength of the light excited by the quantum rods. By arranging the quantum rod layers with different core dimensions, color light conversion at different wavelengths can be achieved. For example, the wavelength of light emitted from the quantum rod layer can be controlled by controlling the diameter of the quantum rods in each quantum rod layer. The smaller the diameter of the core of the quantum rods in the quantum rod layer, the shorter the wavelength of the light emitted from that quantum rod layer.

For example, FIG. 3 is a schematic structural diagram of a dimming layer according to some embodiments of the present disclosure. As shown in FIG. 3, the dimming layer 14 includes a first quantum rod layer 141A and a second quantum rod layer 141B (which are collectively referred to as the quantum rod layer 141) which are laminated in a direction away from the first quarter wave plate 13 (not shown in FIG. 3).

The first quantum rod layer 141A is configured to emit light of a second color under the excitation of linearly polarized light emitted from the first quarter wave plate 13. The second quantum rod layer 141B is configured to emit light of a third color under the excitation of the linearly polarized light emitted from the first quarter wave plate 13. The first color, the second color, and the third color are different colors. The long axis direction of the quantum rods in the first quantum rod layer 141A is the same as the long axis direction of the quantum rods in the second quantum rod layer 141B, and the dimensions of the cores of the quantum rods in the first quantum rod layer 141A are different from the cores of the quantum rods in the second quantum rod layer 141B.

The long axis direction of the quantum rods in the first quantum rod layer 141A is the same as the long axis direction of the quantum rods in the second quantum rod layer 141B, which is not necessarily zero error. Specifically, the long axis direction of the quantum rods in the first quantum rod layer 141A being the sane as the long axis direction of the quantum rods in the second quantum rod layer 141B indicates that the angle between the long axis direction of the quantum rods in the first quantum rod layer 141A and the long axis direction of the quantum rods in the second quantum rod layer 141B is less than a certain error threshold. The error threshold is, for example, 10 degrees. That is, in the case that the angle between the long axis direction of the quantum rods in the first quantum rod layer 141A and the long axis direction of the quantum rods in the second quantum rod layer 141B is less than or equal to 10 degrees, it is considered that the long axis direction of the quantum rods in the first quantum rod layer 141A is the same as the long axis direction of the quantum rods in the second quantum rod layer 141B.

In some embodiments of the present disclosure, the first quantum rod layer is capable of emitting light of a second color upon excitation of light of a first color, in other words, the first quantum rod layer is capable of converting light of one wavelength into light of another wavelength. In addition, the first quantum rod layer is capable of transmitting a portion of the light of the first color to the second quantum rod layer. The second quantum rod layer is capable of emitting light of a third color upon excitation of the light of the first color, that is, the second quantum rod layer is capable of converting light of one wavelength into light of still another wavelength. In addition, the second quantum rod layer is capable of transmitting a portion of the light of the first color and the light of the second color. Because the polarized light emitted through the quantum rod layer is brightest in the long axis direction of the quantum rod, the brightness of the polarized light emitted in the long axis direction of the quantum rod is higher, and the display device including the quantum rod layer can reduce power consumption. Because the dimension of the core of the quantum rods in the first quantum rod layer is different from the dimension of the core of the quantum rods in the second quantum rod layer, the first quantum rod layer and the second quantum rod layer can realize the conversion of color light of different wavelengths.

In some embodiments, the light source is configured to emit blue light, i.e., the first color is blue, and accordingly, the first quantum rod layer and the second quantum rod layer are one of a green quantum rod layer and a red quantum rod layer respectively. The green quantum rod layer is configured to emit green light under the excitation of the blue light. The red quantum rod layer is configured to emit red light under the excitation of the blue light. For example, the dimming layer 14 includes a layer of green quantum rod layers and a layer of red quantum rod layers which are laminated along a direction away from the first quarter wave plate 13. Alternatively, the dimming layer 14 includes a layer of red quantum rods and a layer of green quantum rods which are laminated along a direction away from the first quarter wave plate 13.

In some embodiments, the polarization of the dimming layer 14 is realized in the range of 0.6 to 0.8.

In some embodiments, the thickness of the one layer of quantum rods in the dimming layer 14 ranges from 100 μm to 500 μm, i.e., the thickness of the one layer of quantum rods is not less than 100 μm and not more than 500 μm. For example, the sum of the thicknesses of the green quantum rod layer and the red quantum rod layer described above is 200 micrometers.

Because the thickness of the dimming layer 14 has a certain effect on the polarization degree, in the embodiments of the present disclosure, the polarization degree ranges from 0.21 to 0.85 by arranging the thickness of the quantum rod layer in the range of 100 μm to 500 μm.

In some embodiments, referring to FIG. 3, the dimming layer 14 further includes a first substrate 142 and a second substrate 143. The quantum rod layer 141 is encapsulated between the first substrate 142 and the second substrate 143. With this structure, the thickness of the dimming layer 14 ranges from 200 mm to 6000 mm.

In some embodiments, the thickness of the dimming layer 14 is adjusted by selecting different substrates.

For example, FIG. 4 is a schematic structural diagram of another backlight module according to some embodiments of the present disclosure. As shown in FIG. 4, on the basis of the backlight module 1 as shown in FIG. 1, the backlight module 1 further includes a reflective layer 11. The reflective layer 11 is disposed on a side, away from the first quarter wave plate 13, of the liquid crystal optical layer 12. The liquid crystal optical layer 12 is also configured to reflect another portion of circularly polarized light from the light source to the reflective layer 11. The reflective layer 11 is configured to reflect light reflected by the liquid crystal optical layer 12 to the liquid crystal optical layer 12.

In the embodiments of the present disclosure, by disposing the reflective layer 11 on the side of the liquid crystal optical layer 12 away from the first quarter wave plate, the reflective layer 11 is capable of adjusting the light reflected by the liquid crystal optical layer 12 into circularly polarized light that the liquid crystal optical layer 12 is capable of transmitting, in order to allow the liquid crystal optical layer 12 to be emitted and reused, which improves the light utilization rate of the backlight module 1.

In some embodiments, the liquid crystal optical layer 12 is configured to transmit the circularly polarized light from the light source in a first rotation direction to the first quarter wave plate 13 and reflecting the circularly polarized light from the light source in a second rotation direction to the reflective layer 11, wherein the first rotation direction and the second rotation direction are one of a left rotation direction and a right rotation direction respectively. The reflective layer 11 is configured to reflect the circularly polarized light in the second rotation direction. The liquid crystal optical layer 12 is further configured to transmit the circularly polarized light of the first rotation direction in the light reflected by the reflective layer 11 to the first quarter wave plate 13.

In one possible implementation, the liquid crystal optical layer 12 is a left-handed liquid crystal optical layer. The liquid crystal optical layer 12 includes cholesteric liquid crystals whose pitch rotation direction is left-handed. In this implementation, the liquid crystal optical layer 12 is configured to transmit the right-handed circularly polarized light and reflect the left-handed circularly polarized light. Accordingly, the above first rotation direction is right-handed direction and the second rotation direction is left-handed direction.

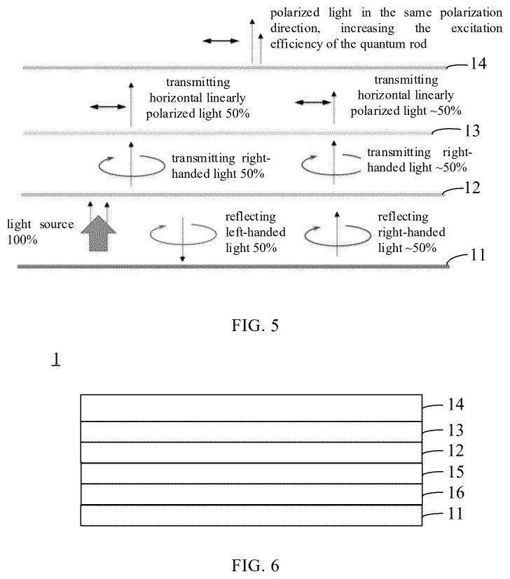

In some embodiments, each of the left-handed circularly polarized light and the right-handed circularly polarized light accounts for 50% of the circularly polarized light emitted by the light source. For example, FIG. 5 is a schematic diagram of light transmission path in the backlight module according to some embodiments of the present disclosure. As shown in FIG. 5, light from the light source is incident to a liquid crystal optical layer 12. The liquid crystal optical layer 12 transmits 50% of the right-handed light. A first quarter wave plate 13 converts the 50% right-handed light into horizontal linearly polarized light and then emits it into the dimming layer 14. In addition, the liquid crystal optical layer 12 reflects the 50% left-handed light to the reflective layer 11. The reflective layer 11 reflects about 50% (˜50%) of the right-handed light to the liquid crystal optical layer 12 based on the 50% left-handed light, causing the liquid crystal optical layer 12 to transmit this about 50% right-handed light. The first quarter wave plate 13 converts this about 50% right-handed light into horizontal linearly polarized light and then emits it into the dimming layer 14. The dimming layer 14 emits polarized light in the same polarization direction as the first quarter wave plate 13.

In another possible implementation, the liquid crystal optical layer 12 is a right-handed liquid crystal optical layer. The liquid crystal optical layer 12 includes cholesteric liquid crystals whose pitch rotation direction is right-handed. In this implementation, the liquid crystal optical layer 12 is configured to transmit the left-handed circularly polarized light and the reflect right-handed circularly polarized light. Accordingly, the above first rotation direction is left-handed rotation and the second rotation direction is right-handed rotation. The optical path transmission in the backlight module under this structure can be referred to FIG. 5, and which is not repeated in the embodiments of the present disclosure.

In some embodiments, FIG. 6 is a schematic diagram of the structure of still another backlight module according to some embodiments of the present disclosure. As shown in FIG. 6, based on the backlight module 1 shown in FIG. 4, the backlight module 1 further includes a second quarter wave plate 16. The second quarter wave plate 16 is disposed between the reflective layer 11 and the liquid crystal optical layer 12.

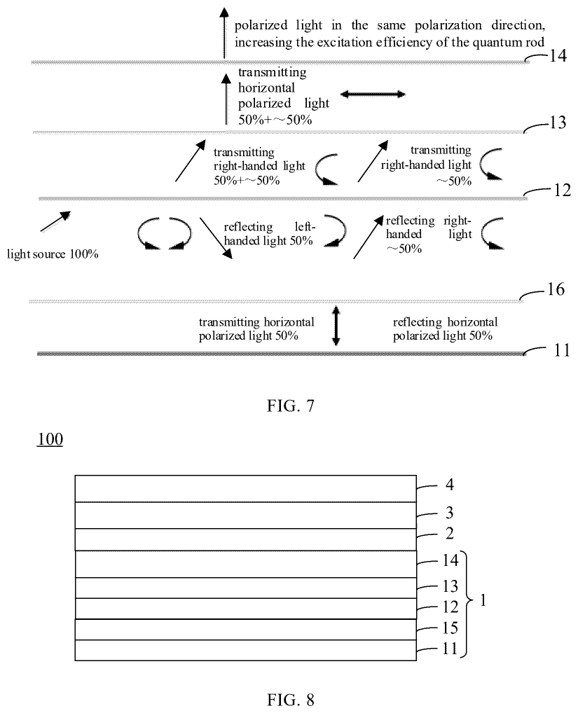

For example, FIG. 7 is a schematic diagram of light transmission path in another backlight module according to some embodiments of the present disclosure. As shown in FIG. 7, light from the light source is incident to the liquid crystal optical layer 12. The liquid crystal optical layer 12 transmits 50% right-handed light. The first quarter wave plate 13 converts this 50% right-handed light into a horizontal polarized light and then emits it into the dimming layer 14. In addition, the liquid crystal optical layer 12 reflects 50% of the left-handed light to the reflecting layer 11. The second quarter wave plate 16 converts this 50% left-handed light into 50% vertically polarized light and is directed to the reflective layer 11. The reflective layer 11 reflects this 50% vertically polarized light to the liquid crystal optical layer 12. The second quarter wave plate 16 converts this 50% vertically polarized light into about 50% right-handed light and continues to transmit it toward the liquid crystal optical layer 12, such that the liquid crystal optical layer 12 transmits this about 50% right-handed light. The first quarter wave plate 13 converts this about 50% right-handed light into horizontal polarized light and the horizontal polarized light is directed into the dimming layer 14. The dimming layer 14 emits polarized light in the same polarization direction as the first quarter wave plate 13.

In some embodiments, the angle between the slow axis direction of the first quarter wave plate 13 and the long axis direction of the quantum rod is 45 degrees or 135 degrees. The slow axis direction of the first quarter wave plate 13 is the direction of the light vector that propagates slowly in the first quarter wave plate 13.

In the first implementation, the liquid crystal optical layer 12 is a left-handed liquid crystal optical layer. The angle between the slow axis direction of the first quarter wave plate 13 and the long axis direction of the quantum rod is 45 degrees.

In a second implementation, the liquid crystal optical layer 12 is a left-handed liquid crystal optical layer. The angle between the slow axis direction of the first quarter wave plate 13 and the long axis direction of the quantum rod is 135 degrees.

In a third implementation, the liquid crystal optical layer 12 is a right-handed liquid crystal optical layer. The angle between the slow axis direction of the first quarter wave plate 13 and the long axis direction of the quantum rod is 135 degrees.

In a fourth implementation, the liquid crystal optical layer 12 is a right-handed liquid crystal optical layer. The angle between the slow-axis direction of the first quarter wave plate 13 and the long axis direction of the quantum rod is 45 degrees.

In the embodiments of the present disclosure, the light extraction rate of the quantum rod is improved by equipping different types of liquid crystal optical layers with different first quarter wave plates and arranging the long axis direction of the quantum rod of the dimming layer to be same as the slow axis of the first quarter wave plate, which is able to improve the light absorption effect, enhance the utilization rate of the backlight, and reduce the power consumption.

In some embodiments, the liquid crystal optical layer 12 includes a cholesteric liquid crystal layer, and the cholesteric liquid crystal layer includes a liquid crystal polymer having a first pitch and a second pitch.

In the embodiments of the present disclosure, the cholesteric liquid crystal layer includes a liquid crystal polymer with a non-uniform distribution of the first pitch and the second pitch, which is capable of realizing 50% selective transmittance and 50% selective reflectance in the range of visible light (wavelengths ranging from 380 nm to 780 nm).

In some embodiments, referring to FIG. 4 or FIG. 6, the backlight module 1 further includes a light guide plate 15. The light guide plate 15 is disposed on the side, away from the first quarter wave plate 13, of the liquid crystal optical layer 12. For example, in the backlight module 1 illustrated in FIG. 4, the light guide plate 15 is disposed between the liquid crystal optical layer 12 and the reflective layer 11. For example, in the backlight module 1 illustrated in FIG. 5, the light guide plate 15 is disposed between the liquid crystal optical layer 12 and the second quarter wave plate 16.

In some embodiments, the backlight module 1 further includes a light source (not shown in the figure). The light source is a micro light emitting diode. In some embodiments, the light source is configured to emit blue light, and the light source is a blue micro light emitting diode. The micro light emitting diode includes, but is not limited to, a mini light-emitting diode (mini LED) and a micro light emitting diode (micro LED). The micro LED refers to ultra-small light emitting diodes with a grain size less than 100 μm. The mini LED refers to small light emitting diodes with a grain size between micro LEDs and conventional LEDs, e.g., the grain size of mini LEDs ranges from 100 μm to 300 μm, and that of micro LEDs ranges from 10 μm to 100 μm.

In some embodiments, the backlight module 1 is an edge-lit backlight module or a direct-type backlight module. In the case that the backlight module 1 is an edge-lit backlight module, the light source is disposed on the side of the light guide plate. In the case that the backlight module 1 is a direct-type backlight module, the light source is disposed on a side of the light guide plate away from the liquid crystal optical layer.

In some embodiments, the backlight module according to the embodiments of the present disclosure is applied to a liquid crystal display.

Based on the same inventive concept, embodiments of the present disclosure also provide a display device including a polarizer and a backlight module. The backlight module 1 is as shown in FIG. 1, FIG. 4, or FIG. 6. The polarizer is disposed on the side of the dimming layer 14 in the backlight module 1 away from the first quarter wave plate 13 in the backlight module 1. In some embodiments, the polarizer is a lower polarizer.

For example, FIG. 8 is a schematic diagram of a structure of the display device according to some embodiments of the present disclosure. As shown in FIG. 8, the display device 100 includes a lower polarizer 2 and a backlight module 1 as shown in FIG. 4.

The display device according to the embodiments of the present disclosure includes the backlight module 1 in any of the above embodiments, the principles and technical effects of which are described in the above embodiments and is not repeated herein.

In some embodiments, the liquid crystal optical layer 12 in the backlight module 1 is a left-handed liquid crystal optical layer, and the quantum rod, the first quarter wave plate 13 and the polarizer 2 in the dimming layer 14 satisfy one of the following relationships: the angle between the long axis direction of the quantum rod and the slow axis direction of the first quarter wave plate 13 is 45 degrees, and the long axis direction of the quantum rod is parallel to the transmission axis of the polarizer 2 (corresponding to the following first implementation); and the angle between the long axis direction of the quantum rod and the direction of the slow axis of the first quarter wave plate 13 is 135 degrees, and the long axis direction of the quantum rod is perpendicular to the transmission axis of the polarizer 2 (corresponding to the following second implementation).

In some embodiments, the liquid crystal optical layer 12 in the backlight module 1 is a right-handed liquid crystal optical layer, and the quantum rod, the first quarter wave plate 13 and the polarizer 2 in the dimming layer 14 satisfy one of the following relationships: the angle between the long axis direction of the quantum rod and the slow axis direction of the first quarter wave plate 13 is 135 degrees, and the long axis direction of the quantum rod is parallel to the transmission axis of the polarizer 2 (corresponding to the following third implementation); and the angle between the long axis direction of the quantum rod and the direction of the slow axis of the first quarter wave plate 13 is 45 degrees, and the long axis direction of the quantum rod is perpendicular to the transmission axis of the polarizer 2 (corresponding to the following fourth implementation).

In the first implementation, the liquid crystal optical layer 12 is a left-handed liquid crystal optical layer. The angle between the long axis direction of the quantum rod and the direction of the slow axis of the first quarter wave plate 13 is 45 degrees, and the long axis direction of the quantum rod is parallel to the transmission axis of the polarizer 2.

In the second implementation, the liquid crystal optical layer 12 is a left-handed liquid crystal optical layer. The angle between the long axis direction of the quantum rod and the slow axis direction of the first quarter wave plate 13 is 135 degrees, and the long axis direction of the quantum rod is perpendicular to the transmission axis of the polarizer 2.

In the third implementation, the liquid crystal optical layer 12 is a right-handed liquid crystal optical layer. The angle between the long axis direction of the quantum rod and the slow axis direction of the first quarter wave plate 13 is 135 degrees, and the long axis direction of the quantum rod is parallel to the transmission axis of the polarizer 2.

In a fourth implementation, the liquid crystal optical layer 12 is a right-handed liquid crystal optical layer. The angle between the long axis direction of the quantum rod and the slow axis direction of the first quarter wave plate 13 is 45 degrees, and the long axis direction of the quantum rod is perpendicular to the transmission axis of the polarizer 2.

In the embodiments of the present disclosure, by equipping different types of liquid crystal optical layers with different first quarter wave plates, and arranging the long axis direction of the quantum rod of the dimming layer and the polarization direction of the polarizer based on the slow axis of the first quarter wave plate, the transmission axis of the polarizer is parallel to the long axis direction of the quantum rod, such that luminous efficacy of the display panel on the side of the lower polarizer away from the backlighting module is higher.

In some embodiments, referring to FIG. 8, the display device 100 further includes an upper polarizer 4 and a display panel 3. The display panel 3 and the upper polarizer 4 are disposed sequentially on the lower polarizer 2 in a direction away from the backlight module 1.

In some embodiments, the display device 100 includes, but is not limited to, a display panel, an electronic paper, a cell phone, a tablet computer, a television set, a monitor, a laptop computer, a digital photo frame, a navigator, and any other product or component having a display function.

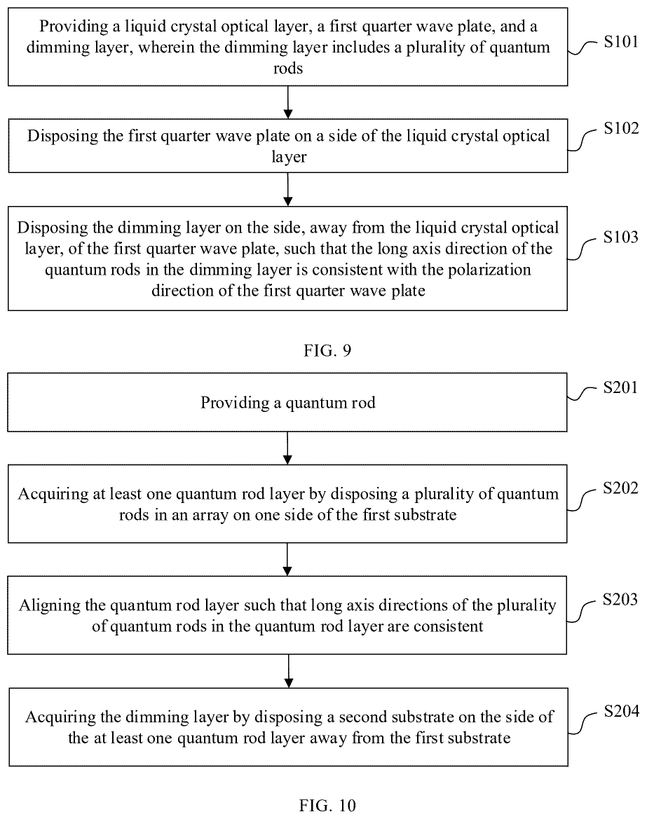

Based on the same inventive concept, embodiments of the present disclosure also provide a method for manufacturing a backlight module. The method can be used to manufacture any of the backlight modules 1 according to the preceding embodiments, including but not limited to the backlight module 1 shown in FIG. 1, FIG. 4, or FIG. 6. FIG. 9 is a flowchart illustrating a process of the method for manufacturing the backlight module according to some embodiments of the present disclosure. As shown in FIG. 9, the method includes the following processes S101 to S103.

In S101, a liquid crystal optical layer, a first quarter wave plate, and a dimming layer are provided, wherein the dimming layer includes a plurality of quantum rods.

In S102, the first quarter wave plate is disposed on a side of the liquid crystal optical layer.

In S103, the dimming layer is disposed on the side, away from the liquid crystal optical layer, of the first quarter wave plate, such that the long axis direction of the quantum rods in the dimming layer is consistent with the polarization direction of the first quarter wave plate.

By the above processes S101 to S103 according to the embodiments of the present disclosure, the backlight module 1 shown in FIG. 1 can be manufactured. In the embodiments of the present disclosure, by a structure including the liquid crystal optical layer, the first quarter wave plate, and the dimming layer including the quantum rods in the backlight module. a high color gamut backlight module is realized without increasing the power consumption, and the backlight module is able to greatly improve the light efficiency of the display device. In addition, the backlight module has a simple structure and is realized at a lower cost, which is more conducive to widespread use.

In some embodiments, the dimming layer provided in the above S101 is acquired by preparation. For example, FIG. 10 is a schematic diagram of an implementation process for preparing a dimming layer according to some embodiments of the present disclosure. As shown in FIG. 10, the implementation flow includes the following processes S201 to S204.

In S201, a quantum rod is provided.

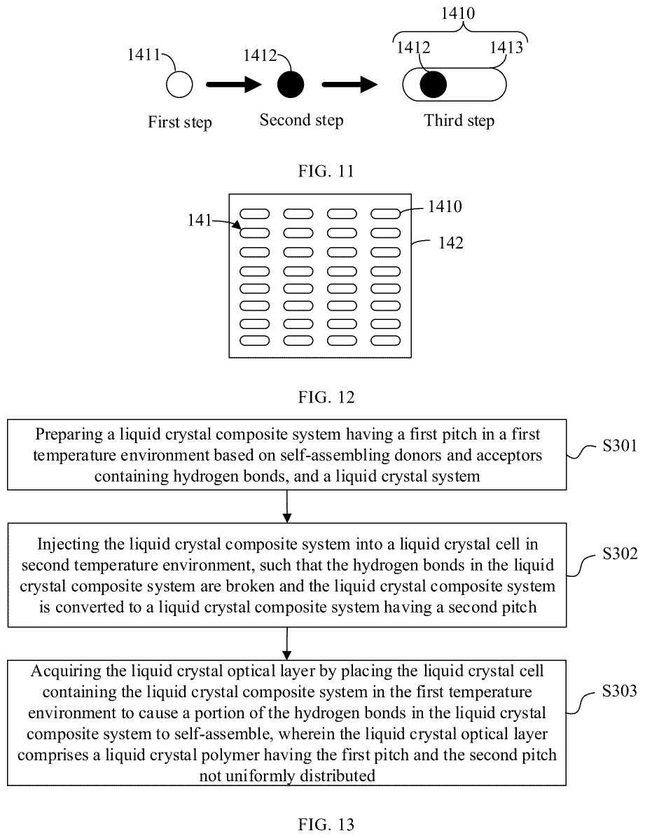

In some embodiments, the quantum rods provided in S201 is acquired by preparation. For example, FIG. 11 is a schematic diagram of preparing a quantum rod according to some embodiments of the present disclosure. As shown in FIG. 11, the process of preparing the quantum rod 1410 is as follows: first, a crystal seed 1411 is synthesized, the crystal seed 1411 including a quantum dot material. Second, the surface of the crystal seed 1411 is activated to acquire a core 1412. Third, a shell 1413 is wrapped around the surface of the core 1412 to acquire the quantum rod 1410.

In some embodiments of the present disclosure, a quantum dot material is usually used as the crystal seed 1411, and the first step is to synthesize the crystal seed 1411, the second step is to carry out surface activation treatment on the synthesized crystal seed 1411 to acquire the core 1412, and the third step is to parcel the shell 1413 outside the core 1412 to form the quantum rod 1410 with a rod-like structure. The anisotropic structure of the quantum rod 1410 allows it to be able to absorb and emit polarized light along the long axis direction. Moreover, the quantum rod 1410 has a higher thermal stability than quantum dots, and can emit light stably even at 150° C., with a light extraction rate about twice the light extraction rate of quantum dots.

In some embodiments, cadmium selenide (Cdse) is used as the core 1412, and cadmium sulfide (Cds) is used as the shell 1413. The cadmium content of the quantum rod 1410 acquired by using Cdse and Cds is low, which complies with the RoHs (Regulation of Hazardous Substances, Directive on the Restriction of the Use of Certain Hazardous Substances) standards.

In S202, at least one quantum rod layer is acquired by disposing a plurality of quantum rods in an array on one side of the first substrate.

For example, FIG. 12 is a schematic diagram of a structure upon forming a quantum rod layer on a first substrate according to some embodiments of the present disclosure. As shown in FIG. 12, a plurality of quantum rods 1410 are disposed on the first substrate 142, and the plurality of quantum rods 1410 form one or more layers of the quantum rod layer 141.

In S203, the quantum rod layer is aligned such that long axis directions of the plurality of quantum rods in the quantum rod layer are consistent.

In this way, in the case that the dimming layer is disposed on the side of the first quarter wave plate away from the liquid crystal optical layer, the plurality of quantum rods in the dimming layer can be oriented such that the long axis direction of the plurality of quantum rods in the dimming layer is the same as the polarization direction of the first quarter wave plate.

In some embodiments of the present disclosure, the quantum rods need to be aligned, and become a quantum rod layer upon alignment. The long axis direction of the quantum rods is the polarization direction of the light. The quantum rod layer is acquired by massively aligning quantum rods oriented in the long axis direction on a first substrate and having fluorescent properties. The dimming layer including the quantum rod layer can be applied to the field of high color gamut and low power consumption of a display device, and the polarization degree can be realized in the range of 0.21 to 0.85.

In some embodiments, the alignment technique of the quantum rod layer includes, but is not limited to, an electric field induced assembly technique, an electrostatic spinning technique, a light-controlled orientation technique, and the like. The light-controlled orientation technique, which is a simple process, can realize large-size plate preparation. The orientation of the quantum rod layer, which is usually an in-plane horizontal uniform orientation, needs to be parallel to the transmission axis of the lower polarizer of the display device, which can ensure the highest light efficiency.

In some embodiments, for the coating preparation of the quantum rod layer, the quantum rod layer can be prepared by inkjet printing or the like.

In S204, the dimming layer is acquired by disposing a second substrate on the side of the at least one quantum rod layer away from the first substrate.

The above process S204 also indicates that the side of the first substrate having the quantum rod layer is encapsulated with the second substrate to acquire the dimming layer. A schematic structure of the dimming layer acquired upon the execution of the process S204 is referred to FIG. 3. In some embodiments, the first substrate 142 includes a first resin layer and a first polyimide layer which are laminated. The second substrate 143 includes a second resin layer and a second polyimide layer which are laminated. The first polyimide layer and the second polyimide layer are disposed close to the quantum rod layer 141. The first resin layer and the second resin layer are disposed away from the quantum rod layer 141.

The dimming layer prepared by the embodiment of the present disclosure has a polarization property. Typically, a rod-shaped anisotropic structure can be formed by wrapping the shell outside the core to absorb and emit polarized light along the long axis, and a dimming layer that absorbs and emits polarized light in the long axis direction can be formed by aligning and uniformly arranging the rod-shaped structure.

In some embodiments, the liquid crystal optical layer provided in process S101 above is acquired by preparation.

For example, FIG. 13 is a flowchart of an implementation process for preparing a liquid crystal optical layer according to some embodiments of the present disclosure. As shown in FIG. 13, the flowchart of the implementation includes the following processes S301 to S303.

In S301, a liquid crystal composite system having a first pitch is prepared in a first temperature environment based on self-assembling donors and acceptors containing hydrogen bonds, and a liquid crystal system.

In some embodiments, the liquid crystal system is a cholesteric liquid crystal system.

In some embodiments, the self-assembling donors and the acceptors containing hydrogen bonds are mixed with the liquid crystal system in a certain ratio to acquire the liquid crystal composite system having a certain pitch in a room temperature. In this process, the first temperature environment is set to the room temperature, such that it is not needed to perform operations such as cooling or heating of the liquid crystal composite system to achieve the purpose of saving the preparation process and cost.

In S302, the liquid crystal composite system is injected into a liquid crystal cell in second temperature environment, such that the hydrogen bonds in the liquid crystal composite system are broken and the liquid crystal composite system is converted to a liquid crystal composite system having a second pitch.

In some embodiments, the cholesteric liquid crystal composite system is subjected to a variable temperature infrared test to determine the hydrogen bond breaking temperature of the hydrogen bond compounds in the system. The hydrogen bond breaking temperature is determined as the second temperature.

In some embodiments, the cholesteric liquid crystal composite system is subjected to a variable temperature UV test, a visible light test, or a near-infrared spectrophotometer test to determine the change in the reflected wave level of the composite system before and after breaking the hydrogen bonds, and thereby determining the pitch of the cholesteric liquid crystal composite system before and after breaking the hydrogen bonds.

In some embodiments, the cholesteric liquid crystal composite system is filled into a liquid crystal cartridge, and the liquid crystal cartridge is subjected to a heat bench. The temperature of the heat bench is controlled at the hydrogen bond breaking temperature of the hydrogen bond compound (i.e., the second temperature) as determined in the preceding processes, and the second pitch of the composite system was fixed by irradiating the composite system using UV light to polymerize the liquid crystalline polymerizable monomers.

In S303, the liquid crystal optical layer is acquired by placing the liquid crystal cell containing the liquid crystal composite system in the first temperature environment to cause a portion of the hydrogen bonds in the liquid crystal composite system to self-assemble, wherein the liquid crystal optical layer includes a liquid crystal polymer having the first pitch and the second pitch not uniformly distributed.

In some embodiments, the liquid crystal system is an aggregated state of crystalline molecules between the solid state and the liquid state, having both the regularity of the arrangement of the crystalline molecules and the fluidity and continuity of the liquid. In the case that the liquid crystal system is converted into the liquid crystal composite system, and the liquid crystal box is cooled down to room temperature (i.e., a first temperature environment), the hydrogen bond donors and acceptors in the liquid crystal composite system tend to self-assemble to form the liquid crystal polymer, but to a certain extent, the self-assembly of the hydrogen bond molecules is impeded by the anchoring effect of the liquid crystal polymer. Therefore, the liquid crystal composite system in the region close to the liquid crystal polymer has a strong anchoring effect, the hydrogen bond molecules are difficult to self-assemble, and the liquid crystal polymer pitch change in this region is small, close to or equal to the second pitch in the second temperature environment. In the region away from the liquid crystal polymer, the anchoring effect is weak, the hydrogen bond molecules are easy to self-assemble, and the pitch change in this region is larger and close to the first pitch upon lowering to room temperature. Therefore, a non-uniform distribution of the pitch is formed within the liquid crystal composite system upon lowering to room temperature, and the cholesteric liquid crystal layer is prepared.

In the above processes S301 to S303 according to some embodiments of the present disclosure, the liquid crystal composite system is prepared using hydrogen bond self-assembly, and the pitch gradient distribution in the liquid crystal composite system is adjusted by controlling the self-assembly of the hydrogen bonds through the temperature, such that a liquid crystal optical layer that realizes 50% selective reflection and selective transmission in the visible light range is acquired.

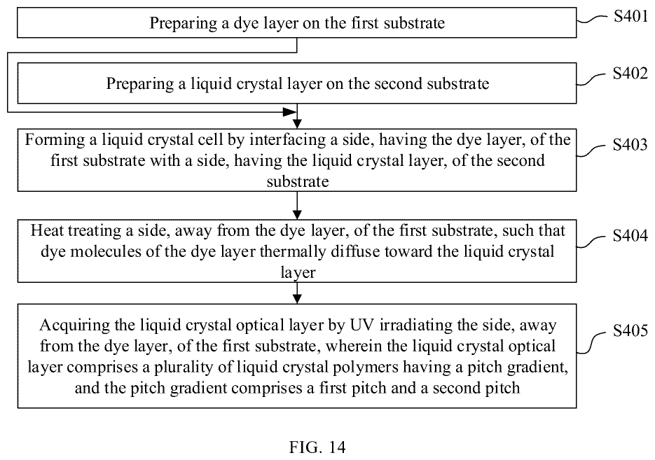

For example, FIG. 14 is a flowchart of another implementation process for preparing a liquid crystal optical layer according to some embodiments of the present disclosure. As shown in FIG. 14, the flowchart includes the following processes S401 to S405.

In S401, a dye layer is prepared on the first substrate.

In some embodiments, the dye layer is prepared on the first substrate by a solvent coating method.

In S402, a liquid crystal layer is prepared on the second substrate.

In S403, a liquid crystal cell is formed by interfacing a side, having the dye layer, of the first substrate with a side, having the liquid crystal layer, of the second substrate.

In some embodiments, interfacing the first substrate with the second substrate to form the liquid crystal cell can be realized by controlling the thickness between the two substrates with glass beads.

In S404, a side, away from the dye layer, of the first substrate is heat treated, such that dye molecules of the dye layer thermally diffuse toward the liquid crystal layer.

In the embodiments of the present disclosure, upon heat treatment to the side of the first substrate away from the dye layer, the dye molecules diffuse toward the liquid crystal layer, such that there are different dye concentration gradients in the liquid crystal layer.

In S405, the liquid crystal optical layer is acquired by UV irradiating the side, away from the dye layer, of the first substrate, wherein the liquid crystal optical layer includes a plurality of liquid crystal polymers having a pitch gradient, and the pitch gradient includes a first pitch and a second pitch.

In the above processes S401 to S405 according to the embodiments of the present disclosure, a temperature difference is used to cause a difference in the distribution of components within the liquid crystal layer to form the liquid crystal polymers having a pitch gradient, such that a liquid crystal optical layer that achieves 50% selective reflection and selective transmission in the visible light range is acquired.

The embodiments of the present disclosure achieve at least the following beneficial effects.

By aligning the polarization direction of the first quarter wave plate with the long axis direction of the quantum rod in the dimming layer, that is, by aligning the polarization direction of the linearly polarized light emitted from the first quarter wave plate with the long axis direction of the quantum rod, it is possible to maximize the absorption of the polarized light in the long axis direction of the quantum rod and maximize the excitement of the quantum rod to emit the fluorescence, thereby increasing the excitation efficiency for the quantum rod in the dimming layer, improving the utilization rate of the backlight, and achieving a high color gamut of the backlight module. By a structure including a liquid crystal optical layer, a first quarter wave plate, and a dimming layer including the quantum rods in the backlight module, the embodiments of the present disclosure realize a high color gamut backlight module without increasing power consumption, and are able to greatly improve the light efficiency of the display device. In addition, the backlight module has a simple structure and is realized at a lower cost, which is more conducive to widespread use.

The dimming layer includes the quantum rod layer, which is capable of improving the transmittance rate of the polarized light, compared to the conventional quantum dot film layer. The transmittance of the dimming layer is related to the arrangement direction of the quantum rods in the quantum rod layer. In the case that the long axis direction of the quantum rods is the same as the polarization direction of the incident polarized light, the quantum rods have the highest rate of light absorption and light extraction, and accordingly, the transmittance of the dimming layer is also the highest. In the embodiments of the present disclosure, the light extraction rate of the dimming layer is improved by arranging the long axis direction of the plurality of quantum rods of the quantum rod layer to be the same as the long axis direction, thereby improving the light transmission rate of the dimming layer.

By disposing the reflective layer on the side of the liquid crystal optical layer away from the first quarter wave plate, the reflective layer is capable of adjusting the light reflected by the liquid crystal optical layer into circularly polarized light that the liquid crystal optical layer is capable of transmitting, in order to allow the liquid crystal optical layer to be emitted and reused, which improves the light utilization rate of the backlight module.

4. By equipping different types of liquid crystal optical layers with different first quarter wave plates, and arranging the long axis direction of the quantum rod of the dimming layer in accordance with the slow axis of the first quarter wave plates in coordination with the long axis direction of the quantum rod of the dimming layer, the light extraction rate of the quantum rod can be improved, the light absorption effect can be improved, the utilization rate of the backlight can be enhanced, and the power consumption can be reduced.

It is to be appreciated by those skilled in the art that steps, measures, and programs having the various operations, methods, and processes already discussed in the present disclosure can be alternated, changed, combined, or deleted. Other steps, measures, and programs having the same characteristics as those in the various operations, methods, and processes already discussed in the present disclosure may also be alternated, altered, rearranged, disassembled, combined, or deleted. Some steps, measures, and schemes in the related art having the same characteristics as those in the various operations, methods, and processes disclosed in the present disclosure can also be alternated, altered, rearranged, decomposed, combined, or deleted.

In the description of the present disclosure, the words “center,” “top,” “bottom,” “front,” “back,” “left,” “right,” “vertical,” “horizontal,” “up,” “bottom,” “inside,” “outside,” and other indications of the orientations or positional relationships, which are exemplary based on the accompanying drawings, are for the purpose of facilitating the description or simplifying the description of the embodiments of the present disclosure, and are not intended to indicate or imply that the device or component referred to has to have a particular orientation, be constructed and operated with a particular orientation, and therefore are not to be construed as a limitation of the present disclosure.

The terms “first” and “second” are used for descriptive purposes only, and are not to be understood as indicating or implying relative importance or implicitly specifying the number of technical features indicated. Thus, a feature defined with the terms “first” and “second” may expressly or impliedly include one or more such features. In the description of the present disclosure, unless otherwise specified, “more than one” means two or more.

In the description of the present disclosure, it is to be noted that, unless otherwise expressly specified and limited, the terms “mounted,” “connected,” and “coupled” are to be understood broadly. For example, it may be a fixed connection, a removable connection, or an integrally connection, and it may be a direct connection, an indirect connection through an intermediate medium, or a connection within two elements. For those of ordinary skill in the art, the specific meaning of the above terms in the disclosure can be understood in specific cases.

In the description of this specification, specific features, structures, materials, or characteristics may be combined in any one or more embodiments or examples in a suitable manner.

It should be understood that while the individual steps in the flowchart of the accompanying drawings are shown sequentially as indicated by the arrows, the order in which these steps are implemented is not limited to the order indicated by the arrows. Unless explicitly stated herein, in some implementation scenarios of embodiments of the present disclosure, the steps in the respective processes may be performed in other orders as desired. Moreover, some or all of the steps in the flowcharts may include multiple sub-steps or multiple stages based on actual implementation scenarios. Some or all of these sub-steps or phases may be executed simultaneously, or may be executed at different moments. In a scenario where the execution moments are different, the order of execution of these sub-steps or phases may be flexibly configured according to the demand, and the embodiments of the present disclosure are not limited thereto.

The foregoing is only a part of the embodiments of the present disclosure, and it should be noted that, for a person of ordinary skill in the art, on the premise of not departing from the technical conception of the program of the present disclosure, the use of other similar means of implementation based on the technical ideas of the present disclosure also falls within the scope of protection of the embodiments of the present disclosure.

1. A backlight module, comprising: a liquid crystal optical layer, a first quarter wave plate and a dimming layer which are laminated; wherein
the dimming layer comprises a plurality of quantum rods, a long axis direction of the quantum rod being consistent with a polarization direction of the first quarter wave plate;
the liquid crystal optical layer is configured to transmit a portion of circularly polarized light from a light source to the first quarter wave plate; and
the first quarter wave plate is configured to convert the circularly polarized light transmitted by the liquid crystal optical layer into linearly polarized light and emit the linearly polarized light into the dimming layer;
wherein the quantum rod is configured to emit light of a color different from a first color under excitation of the linearly polarized light, such that the dimming layer emits light of a color different from the first color, wherein the first color is a color of the light source.

2. The backlight module according to claim 1, wherein the dimming layer comprises at least one quantum rod layer, the quantum rod layer comprising a plurality of quantum rods disposed in an array, wherein long axis directions of the plurality of quantum rods in a same quantum rod layer are consistent.

3. The backlight module according to claim 2, wherein the at least one quantum rod layer comprises a first quantum rod layer and a second quantum rod layer which are laminated in a direction away from the first quarter wave plate;
the first quantum rod layer is configured to emit light of a second color under excitation of the linearly polarized light, and the second quantum rod layer is configured to emit light of a third color under excitation of the linearly polarized light, wherein the first color, the second color, and the third color are different colors; and
the quantum rod comprises a shell and a core disposed within the shell, and a long axis direction of the quantum rod in the first quantum rod layer is consistent with a long axis direction of the quantum rod in the second quantum rod layer, wherein a dimension of the core of the quantum rod in the first quantum rod layer is different from a dimension of the core of the quantum rod in the second quantum rod layer.

4. The backlight module according to claim 2, wherein a thickness of the quantum rod layer ranges from 100 μm to 500 μm.

5. The backlight module according to claim 1, further comprising: a reflective layer, disposed on a side, away from the first quarter wave plate, of the liquid crystal optical layer; wherein
the liquid crystal optical layer is further configured to reflect another portion of the circularly polarized light from the light source to the reflective layer; and
the reflective layer is configured to reflect the light reflected by the liquid crystal optical layer to the liquid crystal optical layer.

6. The backlight module according to claim 5, wherein the liquid crystal optical layer is configured to transmit the circularly polarized light from the light source in a first rotation direction to the first quarter wave plate and reflect the circularly polarized light from the light source in a second rotation direction to the reflective layer, and the first rotation direction and the second rotation direction are one of a left rotation direction and a right rotation direction respectively;
the reflective layer is configured to reflect the circularly polarized light in the second rotation direction; and
the liquid crystal optical layer is configured to transmit the circularly polarized light in the first rotation direction in the light reflected by the reflective layer to the first quarter wave plate.

7. The backlight module according to claim 5, comprising: a second quarter wave plate, disposed between the reflective layer and the liquid crystal optical layer.

8. The backlight module according to claim 1, wherein an angle between a slow axis direction of the first quarter wave plate and the long axis direction of the quantum rod ranges from 45° to 135°.

9. The backlight module according to claim 1, wherein the liquid crystal optical layer comprises a cholesteric liquid crystal layer, wherein the cholesteric liquid crystal layer comprises a liquid crystal polymer having a first pitch and a second pitch.

10. The backlight module according to claim 1, further comprising: the light source, wherein the light source is a micro light-emitting diode.

11. The backlight module according to claim 1, further comprising: a light guide plate, disposed on a side, away from the first quarter wave plate, of the liquid crystal optical layer.

12. The backlight module according to claim 1, wherein the backlight module is an edge-lit backlight module or a direct-type backlight module.

13. A display device, comprising: a polarizer, and a backlight module;
wherein the backlight module comprises: a liquid crystal optical layer, a first quarter wave plate, and a dimming layer which are laminated; wherein
the dimming layer comprises a plurality of quantum rods, a long axis direction of the quantum rod being consistent with a polarization direction of the first quarter wave plate;
the liquid crystal optical layer is configured to transmit a portion of circularly polarized light from a light source to the first quarter wave plate; and
the first quarter wave plate is configured to convert the circularly polarized light transmitted by the liquid crystal optical layer into linearly polarized light and emit the linearly polarized light into the dimming layer;
wherein the quantum rod is configured to emit light of a color different from a first color under excitation of the linearly polarized light, such that the dimming layer emits light of a color different from the first color, wherein the first color is a color of the light source;
wherein the polarizer is disposed on a side, away from the first quarter wave plate in the backlight module, of the dimming layer in the backlight module.

14. The display device according to claim 13, wherein the liquid crystal optical layer in the backlight module is a left-handed liquid crystal optical layer, and the quantum rod in the dimming layer, the first quarter wave plate, and the polarizer satisfy one of the following relationships:
an angle between a long axis direction of the quantum rod and a slow axis direction of the first quarter wave plate is 45°, and the long axis direction of the quantum rod is parallel to a transmission axis of the polarizer;
an angle between the long axis direction of the quantum rod and the slow axis direction of the first quarter wave plate is 135°, and the long axis direction of the quantum rod is perpendicular to the transmission axis of the polarizer.

15. The display device according to claim 13, wherein the liquid crystal optical layer in the backlight module is a right-handed liquid crystal optical layer, and the quantum rod in the dimming layer, the first quarter wave plate, and the polarizer satisfy one of the following relationships:
an angle between a long axis direction of the quantum rod and a slow axis direction of the first quarter wave plate is 135°, and the long axis of the quantum rod is parallel to a transmission axis of the polarizer;
the angle between the long axis direction of the quantum rod and the slow axis direction of the first quarter wave plate is 45°, and the long axis direction of the quantum rod is perpendicular to the transmission axis of the polarizer.

16. A method for manufacturing a backlight module, comprising:
providing a liquid crystal optical layer, a first quarter wave plate and a dimming layer, wherein the dimming layer comprises a plurality of quantum rods;
disposing the first quarter wave plate on a side of the liquid crystal optical layer; and
disposing the dimming layer on a side, away from the liquid crystal optical layer, of the first quarter wave plate, such that a long axis direction of the quantum rods is consistent with a polarization direction of the first quarter wave plate;
wherein the liquid crystal optical layer is configured to transmit a portion of circularly polarized light from a light source to the first quarter wave plate, the first quarter wave plate is configured to convert the circularly polarized light transmitted by the liquid crystal optical layer into linearly polarized light and emit the linearly polarized light into the dimming layer, and the quantum rod is configured to emit light of a color different a first color under excitation of the linearly polarized light, such that the dimming layer emits light of a color different from the first color, wherein the first color is a color of the light source.

17. The method according to claim 16, wherein providing the dimming layer comprises:
providing the quantum rods;
acquiring at least one quantum rod layer by disposing a plurality of quantum rods in an array on a side of a first substrate;
aligning the quantum rod layer such that long axis directions of the plurality of quantum rods in the quantum rod layer are consistent; and
acquiring the dimming layer by disposing a second substrate on a side, away from the first substrate, of the at least one quantum rod layer.

18. The method according to claim 17, wherein providing the quantum rods comprises:
synthesizing a seed crystal, wherein the seed crystal comprises a quantum rod material;
acquiring a core by activating a surface of the seed crystal; and
acquiring the quantum rod by wrapping a shell around the core.

19. The method according to claim 16, wherein providing the liquid crystal optical layer comprises:
preparing a liquid crystal composite system having a first pitch in a first temperature environment based on self-assembling donors and acceptors containing hydrogen bonds, and a liquid crystal system;
injecting the liquid crystal composite system into a liquid crystal cell in second temperature environment, such that the hydrogen bonds in the liquid crystal composite system are broken and the liquid crystal composite system is converted to a liquid crystal composite system having a second pitch; and
acquiring the liquid crystal optical layer by placing the liquid crystal cell containing the liquid crystal composite system in the first temperature environment to cause a portion of the hydrogen bonds in the liquid crystal composite system to self-assemble, wherein the liquid crystal optical layer comprises a liquid crystal polymer having the first pitch and the second pitch which are not uniformly distributed.

20. The method according to claim 16, wherein providing the liquid crystal optical layer comprises:
preparing a dye layer on a first substrate;
preparing a liquid crystal layer on a second substrate;
forming a liquid crystal cell by interfacing a side, having the dye layer, of the first substrate with a side, having the liquid crystal layer, of the second substrate;
heat treating a side, away from the dye layer, of the first substrate, such that dye molecules of the dye layer thermally diffuse toward the liquid crystal layer; and
acquiring the liquid crystal optical layer by UV irradiating the side, away from the dye layer, of the first substrate, wherein the liquid crystal optical layer comprises a plurality of liquid crystal polymers having a pitch gradient, the pitch gradient comprising a first pitch and a second pitch.
